(19) United States
(12) Patent Application Publication
(10) Pub. No.: US 2010/0124342 A1
(43) Pub. Date: May 20, 2010

(54) FORCED ACOUSTIC DIPOLE AND FORCED ACOUSTIC MULTIPOLE ARRAY USING THE SAME

(75) Inventors: Sung Q. LEE, Daejeon (KR); Min Cheol SHIN, Daejeon (KR); Hye Jin KIM, Daejeon (KR); Kang Ho PARK, Daejeon (KR); Jong Dae KIM, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/558,015

(22) Filed: Sep. 11, 2009

(30) Foreign Application Priority Data
Nov. 17, 2008 (KR) 10-2008-0113832
Apr. 8, 2009 (KR) 10-2009-0030182

(51) Int. Cl. H04R 1/40

(52) U.S. Cl. 381/97

(57) ABSTRACT

Provide is a forced acoustic dipole in which a direction of an acoustic lobe can be freely steered by controlling phase and sound pressure of input signals input into first and second sound sources, respectively. Accordingly, when a forced acoustic multipole array is configured by arranging a plurality of forced acoustic dipoles and a direction of an acoustic lobe is steered in a particular direction by controlling phase and sound pressure of input signals input into the first and second sound sources, respectively, it is possible for a sound to be heard in a desired location without auditory disturbance to others.

### CROSS-REFERENCE TO RELATED APPLICATION

This application claims the benefit of Korean Patent Application Nos. 10-2008-0113832, filed Nov. 17, 2008, and 10-2009-0030182, filed Apr. 8, 2009, the disclosures of which are hereby incorporated herein by reference in their entirety.

### BACKGROUND OF THE INVENTION

1. Field of the Invention

The present invention relates to a forced acoustic dipole and a forced acoustic multipole array using the same, and more particularly, to a forced acoustic dipole in which a direction of an acoustic lobe can be freely steered and a forced acoustic multipole array using the same.

2. Description of Related Art

When an ordinary speaker is used for reproducing sound, there is auditory disturbance to others because of a natural radiating characteristic of sound. For this reason, headphones and earphones are used as personal acoustic devices for minimizing auditory disturbance to others and maintaining privacy, but this introduces a problem of sensory occlusivity. Accordingly, a personal acoustic system capable of minimizing auditory disturbance to others while overcoming the problem of sensory occlusivity is required.

As an example of such a personal acoustic system, a line speaker array system generating a directional lobe using a line speaker array has been disclosed.

The line speaker array system is configured to make an acoustic signal pass through a digital filter adjusted to be directional and output it, and thus it is possible for a sound to be heard at a designated location.

However, the line speaker array system has the following disadvantages. Since a filter must be attached to each speaker, the greater the number of speakers, the more complicated the structure of the system becomes. A side lobe is generated due to bad spatial resolution in high frequencies. Further, since a length of the speaker array should be lengthened in proportion to a wavelength to control sound in low frequencies, a range of controllable frequencies is limited by the length of the speaker array. In particular, because an optimum directional characteristic changes according to a frequency due to a fixed location of the speakers, many filters are required and optimum filter coefficients must be calculated one by one to obtain optimum directional characteristics at each frequency.

Recently, a simple speaker system using an acoustic dipole has been disclosed in order to overcome the above problems. However, this speaker system has a limit in that a direction of an acoustic lobe in which a sound can be heard cannot be freely steered due to characteristics of an acoustic dipole.

### SUMMARY OF THE INVENTION

The present invention is directed to providing a forced acoustic dipole in which a direction of an acoustic lobe can be freely steered and a forced acoustic multipole array using the same.

One aspect of the present invention provides a forced acoustic dipole including: a phase and sound pressure adjustment circuit configured to adjust phase and sound pressure of input signals; and first and second sound sources configured to receive the input signals whose phase and sound pressure are adjusted by the phase and sound pressure adjustment circuit, respectively, and output the received signals as first and second acoustic signals in an audible frequency.

Meanwhile, another aspect of the present invention provides a forced acoustic multipole array including a plurality of forced acoustic dipoles which are arranged in a matrix. Here, each of the forced acoustic dipoles includes: a phase and sound pressure adjustment circuit configured to adjust phase and sound pressure of input signals; and first and second sound sources configured to receive the input signals, respectively, and output the received signals as first and second acoustic signals in an audible frequency.

The first and second acoustic signals output from the first and second sound sources may be offset or amplified by the phase and sound pressure adjustment circuit to steer a direction of an acoustic lobe according to the first and second acoustic signals in a particular direction.

The phase and sound pressure adjustment circuit may include an inverting circuit configured to input signals having opposite phases to each other into the first and second sound source, respectively. The inverting circuit may include: a connecting line configured to input the input signals into terminals having different polarities from each other of the first and second sound source; and an inverter or a digital signal processor configured to invert the phase of the input signal input into the first sound source and input the phase-inverted signal into the second sound source.

Meanwhile, the phase and sound pressure adjustment circuit may include a digital signal processor configured to adjust phase and sound pressure of the input signal in a time domain or a digital signal processor configured to adjust phase and sound pressure of the input signal in a frequency domain.

### BRIEF DESCRIPTION OF THE DRAWINGS

The above and other features of the present invention will be described in reference to certain exemplary embodiments thereof with reference to the attached drawings in which:

FIGS. 1A and 1B are diagrams for describing a basic configuration of a forced acoustic dipole;

FIG. 2 illustrates an inverting circuit for inputting input signals having opposite phases to each other into first and second sound sources of a forced acoustic dipole, respectively, according to a first exemplary embodiment of the present invention;

FIG. 3 illustrates an inverting circuit for inputting input signals having opposite phases to each other into first and second sound sources of a forced acoustic dipole, respectively, according to a second exemplary embodiment of the present invention;

FIG. 4 illustrates an inverting circuit for inputting input signals having opposite phases to each other into first and second sound sources of a forced acoustic dipole, respectively, according to a third exemplary embodiment of the present invention;

FIGS. 5A, 5B and 5C are diagrams for explaining why an acoustic radiating characteristic of a forced acoustic dipole varies;

FIG. 6 is a diagram illustrating a direction of an acoustic lobe generated when a forced acoustic multipole array is configured by arranging two forced acoustic dipoles of the present invention in one row and two columns;

FIG. 7 is a diagram illustrating a direction of an acoustic lobe generated when a forced acoustic multipole array is configured by arranging four forced acoustic dipoles of the present invention in two rows and two columns;

FIG. 8 illustrates a phase and sound pressure adjustment circuit for adjusting phase and sound pressure of an input signal input into first and second sound sources of a forced acoustic dipole, respectively, according to a first exemplary embodiment of the present invention;

FIGS. 9A and 9B illustrate a phase and sound pressure adjustment circuit for adjusting phase and sound pressure of an input signal input into first and second sound sources of a forced acoustic dipole, respectively, according to a second exemplary embodiment of the present invention; and

FIG. 10 is a diagram illustrating a direction of an acoustic lobe generated when a forced acoustic multipole array is configured by arranging forced acoustic dipoles having adjustable phase and sound pressure in n rows and m columns.

### DETAILED DESCRIPTION OF THE INVENTION

Hereinafter, exemplary embodiments of the present invention will be described in detail.

To facilitate understanding of the present invention, a forced acoustic dipole will be described in brief below.

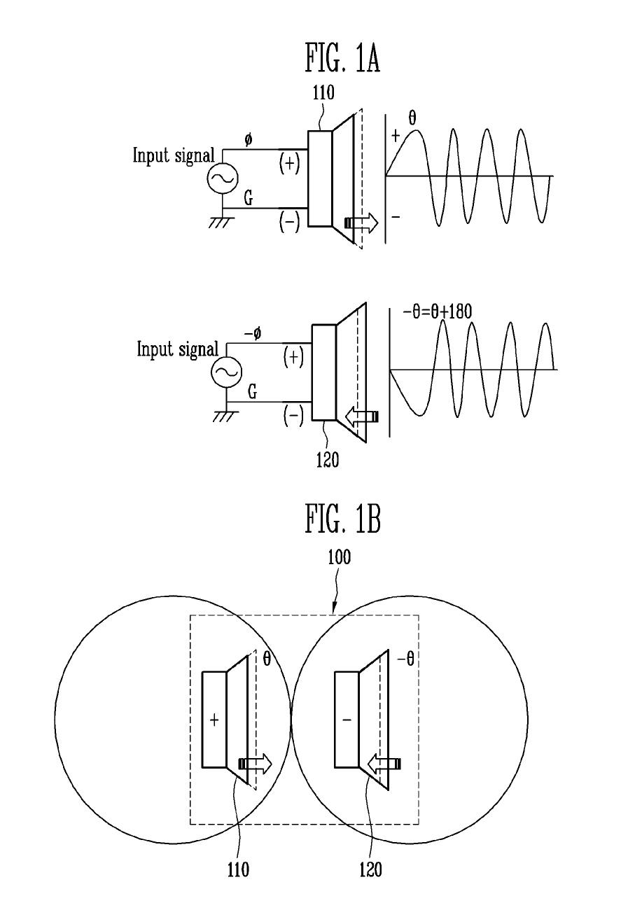

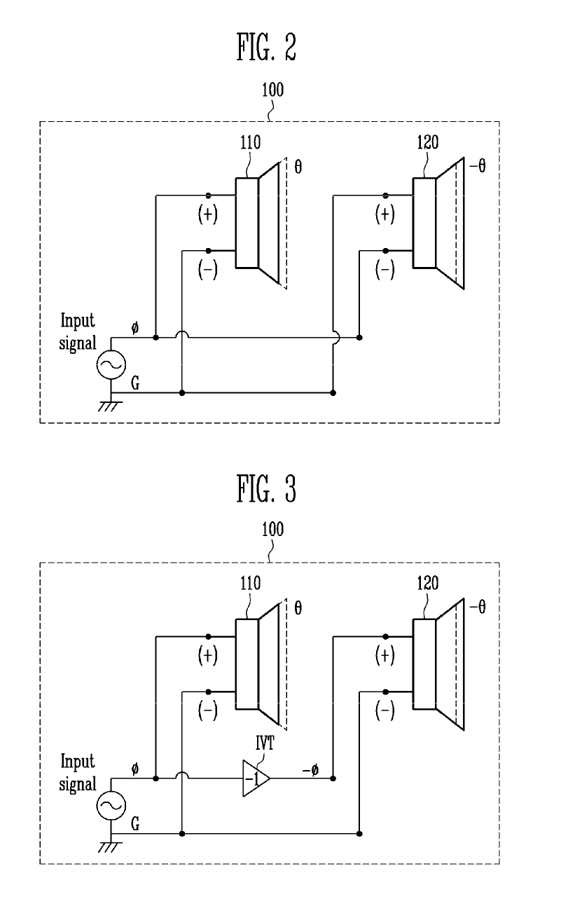

FIGS. 1A and 1B are diagrams for describing a basic configuration of a forced acoustic dipole.

Referring to FIG. 1A, when an input signal of in-phase Φ is input into a positive terminal (+) of a first sound source 110, a diaphragm vibrates forward and an acoustic signal of in-phase θ is output. When an input signal of out-of-phase −Φ is input into a positive terminal (+) of a second sound source 120, a diaphragm vibrates in a reverse direction and an acoustic signal of out-of-phase −θ is output.

The forced acoustic dipole uses acoustic characteristics of the first and second sound sources 110 and 120 as above. As shown in FIG. 1B, when the forced acoustic dipole is configured to arrange the first sound source 110 for outputting an acoustic signal of in-phase θ and the second sound source 120 for outputting an acoustic signal of out-of-phase −θ to be adjacent to each other, the two acoustic signals θ and −θ output from the first and second sound sources 110 and 120 are offset or amplified, and thus an acoustic lobe is generated in front and rear directions of the forced acoustic dipole 100.

Herein, the first and second sound sources 110 and 120 may be implemented with one of a Voice Coil Motor type speaker, a piezoelectric speaker, an ultrasonic transducer and so on, in order to convert an input signal into an acoustic signal of audio frequency and output it.

In the forced acoustic dipole 100 according to the present invention, the direction of the acoustic lobe can be freely steered by controlling the phase and sound pressure of the input signals input into the first and second sound sources 110 and 120. This will be described in further detail below.

An inverting circuit for inputting input signals having opposite phases to each other into the first and second sound sources, respectively, will be first described, and thereafter, a phase and sound pressure adjustment circuit for adjusting phase and sound pressure of the input signals input into the first and second sound sources will be described.

FIG. 2 illustrates an inverting circuit for inputting input signals having opposite phases to each other into the first and second sound sources 110 and 120 of the forced acoustic dipole 100, respectively, according to a first exemplary embodiment of the present invention.

Referring to FIG. 2, an input signal of in-phase Φ is input into a positive terminal (+) of the first sound source 110, and a ground is connected to a negative terminal (−) of the first sound source 110. On the other hand, in the second sound source 120, a ground is connected to a positive-terminal (+), and an input signal of in-phase Φ is input into a negative-terminal (−).

In this way, the input signal of in-phase Φ is input into terminals having different polarities from each other of the first and second sound sources 110 and 120, and thus input signals having opposite phases to each other are input into the first and second sound sources 110 and 120, respectively.

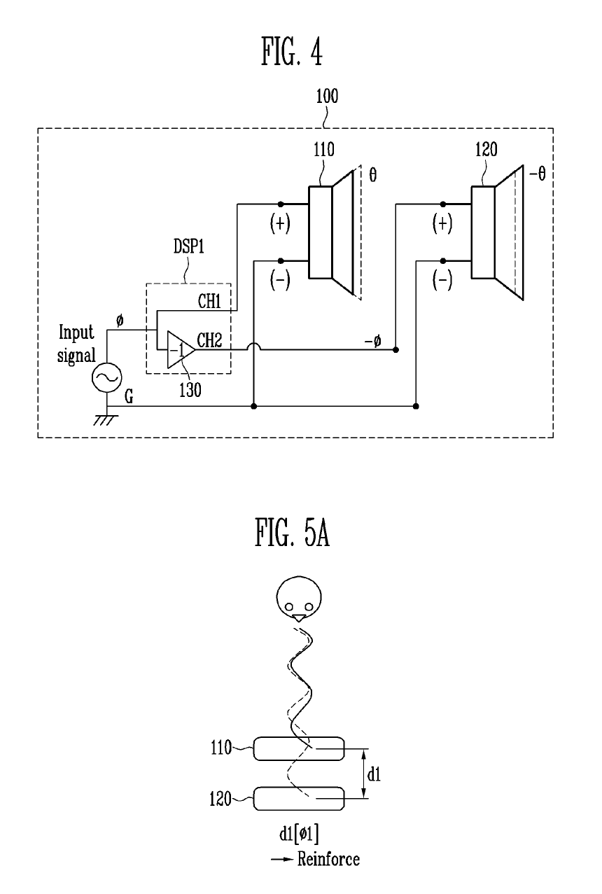

FIG. 3 illustrates an inverting circuit for inputting input signals having opposite phases to each other into the first and second sound sources 110 and 120 of the forced acoustic dipole 100, respectively, according to a second exemplary embodiment of the present invention.

Referring to FIG. 3, an input signal of in-phase Φ is input into a positive terminal (+) of the first sound source 110, and the input signal of in-phase Φ is inverted by an inverter IVT so that an input signal of out-of-phase −Φ is input into a positive terminal (+) of the second sound source 120.

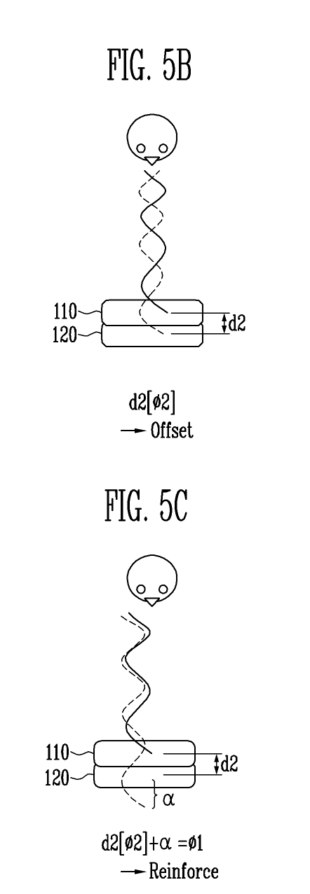

FIG. 4 illustrates an inverting circuit for inputting input signals having opposite phases to each other into the first and second sound sources 110 and 120 of the forced acoustic dipole 100, respectively, according to a third exemplary embodiment of the present invention.

Referring to FIG. 4, an input signal of in-phase Φ is input as an input signal CH1 of the first sound source 110 via a digital signal processor DSP1. The input signal of in-phase Φ is inverted by a phase inverter 130 inside the digital signal processor DSP1, so that an input signal of out-of-phase −Φ is input as an input signal CH2 into a positive terminal (+) of the second sound source 120.

In this case, it is possible to adjust the phase of the input signal CH1 input into the first sound source 110 according to necessity.

Meanwhile, the acoustic radiating characteristics of the forced acoustic dipole 100 vary according to the distance between the first sound source 110 and the second sound source 120 and a difference in phase of the input signals input into the first and second sound sources 110 and 120, respectively. This will be described in further detail below.

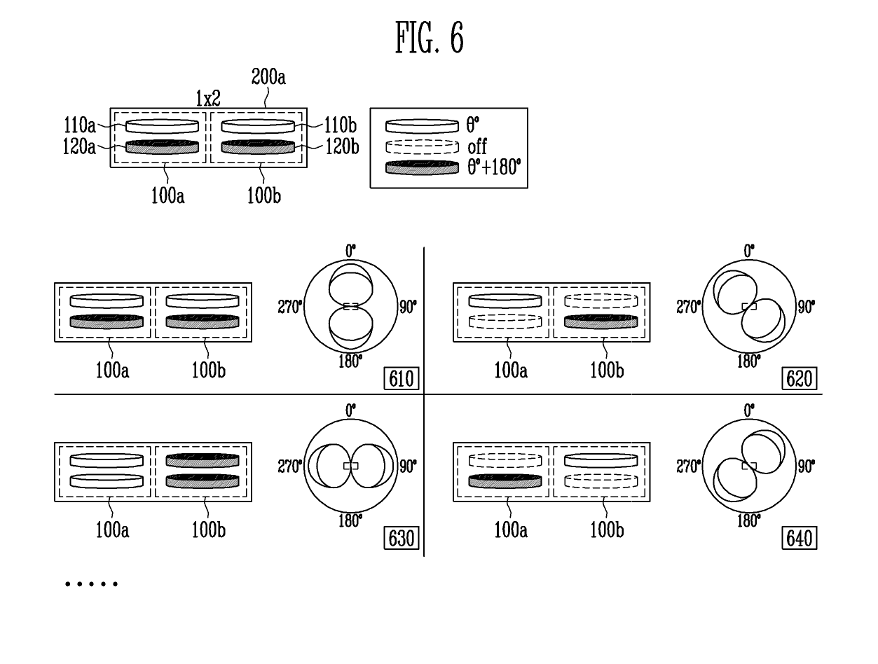

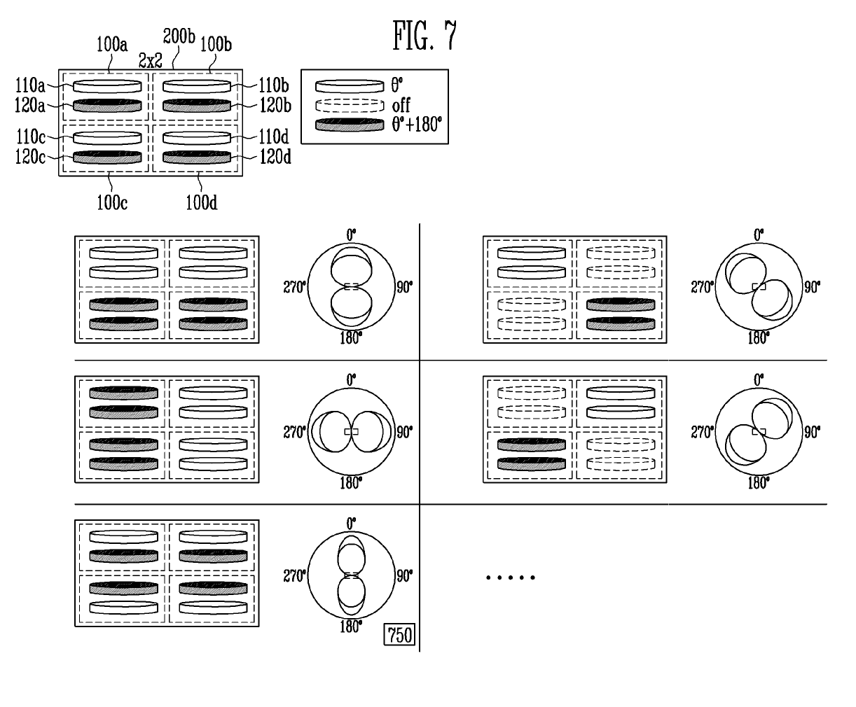

FIGS. 5A, 5B and 5C are diagrams for explaining why acoustic radiating characteristics of the forced acoustic dipole 100 vary.

As illustrated in FIG. 5A, when a distance between the first sound source 110 and the second sound source 120 is d1 and a difference in phase of input signals input into the first and second sound sources 110 and 120 is Φ1, acoustic signals output from the first and second sound sources 110 and 120 reinforce each other, and thus a loud sound is heard by a listener.

However, as illustrated in FIG. 5B, when a distance between the first sound source 110 and the second sound source 120 is d2 and a difference in phase of input signals input into the first and second sound sources 110 and 120 is Φ2, acoustic signals output from the first and second sound sources 110 and 120 are offset each other, and thus no sound is heard by the listener.

In this state, as illustrated in FIG. 5C, when the difference in phase of input signals input into the first and second sound sources 110 and 120, Φ1, is equal to the sum of Φ2 and α by shifting the phase of the input signal input into the second sound source 120 by α, acoustic signals output from the first and second sound sources 110 and 120 reinforce each other, and thus a loud sound is heard again by the listener.

Consequently, the acoustic radiating characteristics of the forced acoustic dipole 100 vary according to the distance between the first sound source 110 and the second sound source 120 and the difference in phase of input signals input into the first and second sound sources 110 and 120, respectively.

In other words, a listener can hear a sound continuously by either changing the distance between the first sound source 110 and the second sound source 120 or shifting the difference in phase of input signals input into the first and second sound sources 110 and 120, respectively, even if the listener's location is changed.

But, because physically changing the distance between the first sound source 110 and the second sound source 120 whenever the listener's location is changed is very difficult, in the present invention, the acoustic radiating characteristics of the forced acoustic dipole 100 may be controlled by shifting the difference in phase of input signals input into the first and second sound sources 110 and 120, respectively. This will be described in further detail below.

FIG. 6 is a diagram illustrating a direction of an acoustic lobe generated when a forced acoustic multipole array is configured by arranging two forced acoustic dipoles of the present invention in one row and two columns. For convenience of explanation, the forced acoustic dipoles shown in FIGS. 2 to 4 are illustrated as blocks.

First, when input signals of in-phase and out-of-phase are input into first and second sound sources 110a and 120a of a first forced acoustic dipole 100a, respectively, and input signals of in-phase and out-of-phase are input into first and second sound sources 110b and 120b of a second forced acoustic dipole 100b, respectively, as shown in an acoustic lobe 610, sound is heard only in front and rear directions of a forced acoustic multipole array 200a, and not on left and right sides thereof.

Second, when an input signal of in-phase is input into the first sound source 110a of the first forced acoustic dipole 100a, an input signal of out-of-phase is input into the second sound source 120b of the second forced acoustic dipole 100b and the remaining sound sources are off, an acoustic lobe 620 is generated.

Third, when input signals of in-phase are input into the first and second sound sources 110a and 120a of the first forced acoustic dipole 100a and input signals of out-of-phase are input into the first and second sound sources 110b and 120b of the second forced acoustic dipole 100b, as shown in an acoustic lobe 630, sound is heard only in left and right sides of the forced acoustic dipole.

Fourth, when an input signal of out-of-phase is input into the second sound source 120a of the first forced acoustic dipole 100a, an input signal of in-phase is input into the first sound source 110b of the second forced acoustic dipole 100b and the remaining sound sources are off, an acoustic lobe 640 is generated.

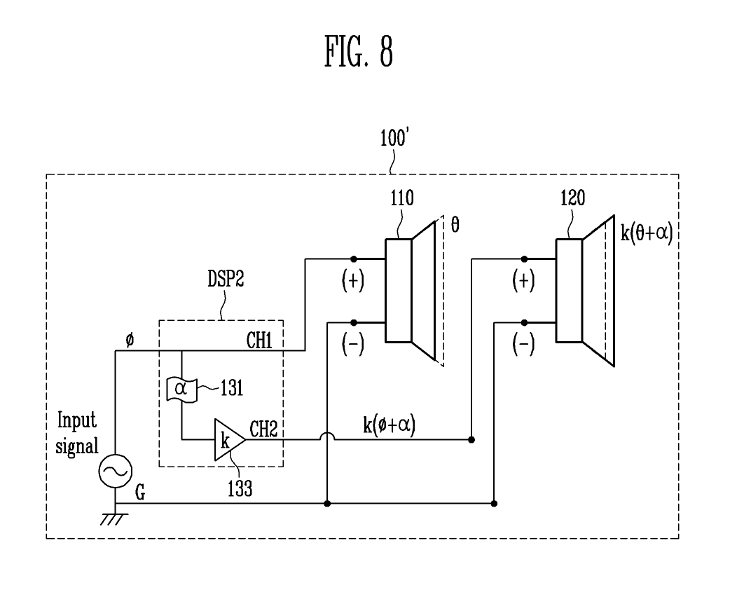

FIG. 7 is a diagram illustrating a direction of an acoustic lobe generated when a forced acoustic multipole array is configured by arranging four forced acoustic dipoles of the present invention in two rows and two columns.

Referring to FIG. 7, in a forced acoustic multipole array 200b including four forced acoustic dipoles 100a to 100d arranged in two rows and two columns, a direction of an acoustic lobe is changed similarly to the forced acoustic multipole array 200a including two forced acoustic dipoles arranged in one row and two columns, but the width of an acoustic lobe 750 becomes narrower.

Consequently, by adjusting the phases of input signals which are input into the first and second sound sources 110 and 120 of each forced acoustic dipole 100, respectively, or adjusting the sound pressures of input signals which are input into the first and second sound sources 110 and 120 including turning the first and second sound sources 110 and 120 on or off, it is possible to freely change the directions and widths of acoustic lobes of the forced acoustic multipole arrays 200a and 200b.

Next, a phase and sound pressure adjustment circuit for adjusting phase and sound pressure of input signals input into the first and second sound sources 110 and 120, respectively, will be described.

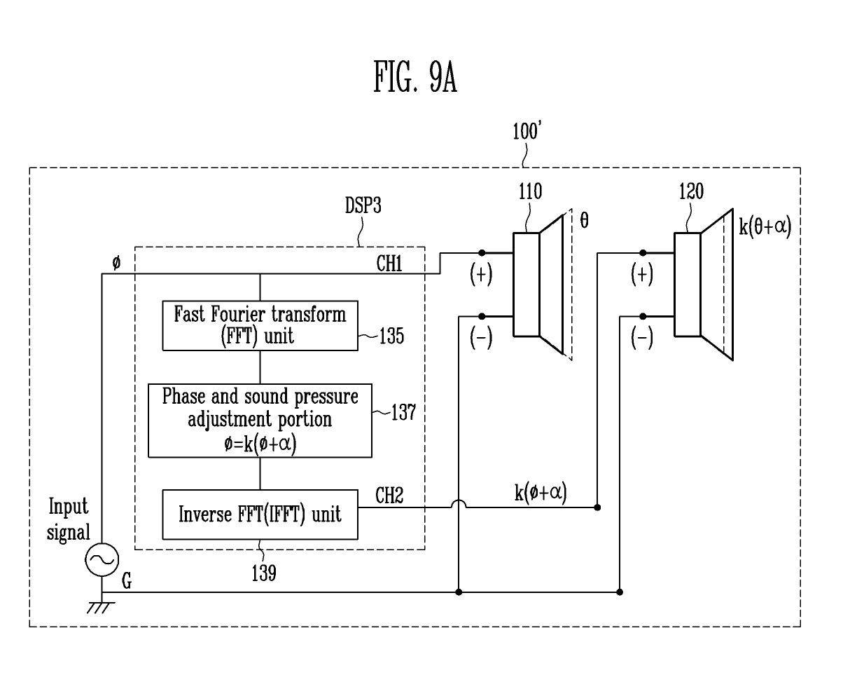

FIG. 8 is a diagram illustrating a phase and sound pressure adjustment circuit for adjusting phase and sound pressure of input signals input into first and second sound sources 110 and 120 of a forced acoustic dipole 100′, respectively, according to a first exemplary embodiment of the present invention.

Referring to FIG. 8, an input signal of in-phase Φ is input as an input signal CH1 of the first sound source 110 via a digital signal processor DSP2. The input signal of in-phase Φ is phase-shifted by a by a phase shifter 131 inside the signal processor DSP2 and the sound pressure thereof is adjusted by a factor of k. Then, the input signal of in-phase Φ is input as an input signal CH2 of the second sound source 120.

More specifically, the input signal of in-phase Φ is input into the first sound source 110, but, an input signal k(Φ+α) having a phase shifted by a in comparison with the input signal of in-phase Φ and a sound pressure adjusted by a factor of k is input into the second sound source 120.

In other words, when a listener's location is changed, it is possible to freely change the direction of the acoustic lobe of the forced acoustic dipole 100′ without changing the distance between the first sound source 110 and the second sound source 120 by adjusting phase and sound pressure of input signals input into the first and second sound sources 110 and 120, respectively.

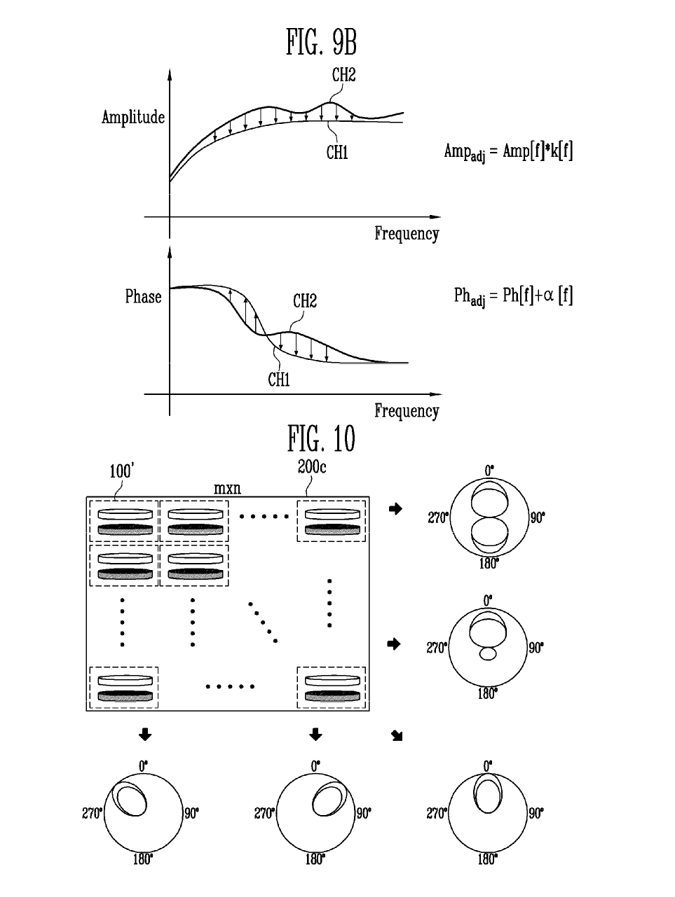

FIGS. 9A and 9B are diagrams illustrating a phase and sound pressure adjustment circuit for adjusting phase and sound pressure of input signals input into the first and second sound sources 110 and 120 of the forced acoustic dipole 100′, respectively, according to a second exemplary embodiment of the present invention.

Referring to FIG. 9A, an input signal of in-phase Φ is input as an input signal CH1 of the first sound source 110 via a digital signal processor DSP3. The input signal of in-phase Φ is transformed into a signal of a frequency domain by a fast Fourier transform (FFT) unit 135 inside the signal processor DSP3. Here, the phase is shifted by a and the sound pressure is adjusted by a factor of k in each frequency spectrum by a phase and sound pressure adjustment portion 137. The input signal having the shifted phase and adjusted sound pressure is again transformed into a signal of a time domain by an inverse FFT (IFFT) unit 139, and thus input as an input signal CH2 of the second sound source 120.

Accordingly, as shown in FIG. 9B, in the input signal CH2 of the second sound source 120, the sound pressure (amplitude) is decreased by a factor of k and the phase is shifted by α, and thus the input signal CH2 has the same phase and sound pressure as the input signal CH1 of the first sound source 110.

FIG. 10 is a diagram illustrating a direction of an acoustic lobe generated when a forced acoustic multipole array 200c is configured by arranging forced acoustic dipoles 100′ having adjustable phase and sound pressure in n rows and m columns (where m and n are integers greater than 1).

Referring to FIG. 10, when input signals input into first and second sound sources 110 and 120 of each forced acoustic dipole 100′ are phase-shifted at different angles and sound pressures thereof are properly adjusted, acoustic signals having various phases and sound pressures are output, respectively, and thus the direction of an acoustic lobe can be controlled more precisely.

Consequently, the present invention provides a forced acoustic dipole in which a direction of an acoustic lobe can be freely steered by controlling phase and sound pressure of input signals input into first and second sound sources, respectively, and thus it is possible to output a sound in a desired location and realistic acoustic effects can be provided without auditory disturbance to others.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A forced acoustic dipole comprising:
a phase and sound pressure adjustment circuit configured to adjust phase and sound pressure of input signals; and
first and second sound sources configured to receive the input signals whose phase and sound pressure are adjusted by the phase and sound pressure adjustment circuit, respectively, and output the received signals as first and second acoustic signals in an audible frequency.

2. The forced acoustic dipole according to claim 1, wherein the first and second acoustic signals output from the first and second sound sources are offset or amplified by the phase and sound pressure adjustment circuit to steer a direction of an acoustic lobe according to the first and second acoustic signals in a particular direction.

3. The forced acoustic dipole according to claim 1, wherein the phase and sound pressure adjustment circuit comprises an inverting circuit configured to input signals having opposite phases to each other into the first and second sound sources, respectively.

4. The forced acoustic dipole according to claim 3, wherein the inverting circuit comprises a connecting line for inputting the input signals into terminals having different polarities from each other of the first and second sound sources.

5. The forced acoustic dipole according to claim 3, wherein the inverting circuit comprises an inverter or a digital signal processor configured to invert the phase of an input signal input into the first sound source and input the phase-inverted signal into the second sound source.

6. The forced acoustic dipole according to claim 1, wherein the phase and sound pressure adjustment circuit comprises a digital signal processor configured to adjust the phase and sound pressure of the input signal in a time domain,
wherein the digital signal processor comprises a phase shifter and a sound pressure adjustment portion configured to adjust the phase and sound pressure of the input signal in a time domain, respectively.

7. The forced acoustic dipole according to claim 1, wherein the phase and sound pressure adjustment circuit comprises a digital signal processor configured to adjust the phase and sound pressure of the input signal in a frequency domain,
wherein the digital signal processor comprises:
a fast Fourier transform (FFT) unit configured to transform the input signal in a time domain into a signal in the frequency domain;
a phase and sound pressure adjustment portion configured to adjust the phase and sound pressure of the input signal which is transformed into the signal in the frequency domain by the FFT unit; and
an inverse FFT (IFFT) unit configured to transform the input signal whose phase and sound pressure are adjusted back into the signal in the time domain.

8. The forced acoustic dipole according to claim 1, wherein each of the first and second sound sources comprises one of a voice coil motor type speaker, a piezoelectric speaker and an ultrasonic transducer.

9. A forced acoustic multipole array comprising a plurality of forced acoustic dipoles which are arranged in a matrix,
wherein each of the forced acoustic dipoles comprises:
a phase and sound pressure adjustment circuit configured to adjust phase and sound pressure of input signals; and
first and second sound sources configured to receive the input signals, respectively, and output the received signals as first and second acoustic signals in an audible frequency.

10. The forced acoustic multipole array according to claim 9, wherein several acoustic signals output from the respective forced acoustic dipoles are offset or amplified by the phase and sound pressure adjustment circuit to steer a direction of an acoustic lobe according to the acoustic signals in a particular direction.

11. The forced acoustic multipole array according to claim 9, wherein the phase and sound pressure adjustment circuit comprises an inverting circuit configured to input signals having opposite phases to each other into the first and second sound source, respectively,
wherein the inverting circuit comprises:
a connecting line configured to input the input signals into terminals having different polarities from each other of the first and second sound source; and
an inverter or a digital signal processor configured to invert the phase of the input signal input into the first sound source and input the phase-inverted signal into the second sound source.

12. The forced acoustic multipole array according to claim 9, wherein the phase and sound pressure adjustment circuit comprises a digital signal processor configured to adjust phase and sound pressure of the input signal in a time domain or a digital signal processor configured to adjust phase and sound pressure of the input signal in a frequency domain.
